(19) United States
(12) Patent Application Publication
(10) Pub. No.: US 2005/0268258 A1
(43) Pub. Date: Dec. 1, 2005

(54) Rule-based design consultant and method for integrated circuit design

(75) Inventor: John Decker, Annandale, NJ (US)

Correspondence Address: STERNE, KESSLER, GOLDSTEIN & FOX PLLC, 1100 NEW YORK AVENUE, N.W., WASHINGTON, DC, 20005, US

(73) Assignee: Tera Systems, Inc., San Jose, CA (US)

(21) Appl. No.: 11/141,386

(22) Filed: Jun. 1, 2005

Related U.S. Application Data
(60) Provisional application No. 60/575,363, filed on Jun. 1, 2004.

(51) Int. Cl. G06F 17/50

(52) U.S. Cl. 716/4

(57) ABSTRACT

A rule-based design consultant and analysis method for an integrated circuit (“IC”) layout design compares an IC design against a list of rules. The IC design information may be included in a set of databases, including a database containing physical implementation and technology specific timing and area information. The consultant and method can be used with a graphical user interface that displays a report of the rules run on the IC design. Cross-probing may be incorporated to display at least one diagram of an object that is not compliant with a particular rule, as well as relevant source code for the object.

### CROSS-REFERENCE TO RELATED APPLICATIONS

The present invention claims the benefit of U.S. Provisional Application No. 60/575,363, filed Jun. 1, 2004, which is hereby incorporated by reference in its entirety.

### BACKGROUND OF THE INVENTION

Traditional rule checkers for integrated circuits (“ICs”) were developed primarily to check for functional verification and detection of simulation issues. The first generation of these checkers were simple language semantic checkers, such as Nova-Verilint, which is a language purification tool for design analysis produced by Synopsys, and LEDA, also produced by Synopsys. The basic technology component involved in this type of checking was a parser for the language being checked. These semantic checkers had limited effectiveness and little or no visualizations.

Semantic checkers evolved into structural rule checkers: Structural rule checkers mapped coded language for a design onto a simple generic structural netlist or read a gate-level representation of the design. This process allowed for a set of synthesizability checks, and more complex structural checking such as the existence of latches, unregistered outputs, and simple clock structure checks.

An example structural rule checker is Spyglass by Atrenta. Structural rule checkers add the ability to do more complex checking involving logic cones and searching a netlist. Structural checks also allow creation of basic schematics and logic-level timing analysis, which uses rough estimates to locate timing issues. LEDA, by Synopsys, also performs some clock gating and cross-clock domain path checking on a structural level.

These traditional tools do not provide timing analysis or checks of the physical implementation. What is needed therefore is a rule checking device and method based on information from a physical layout of the IC.

### BRIEF SUMMARY OF THE INVENTION

In addition to analyzing semantic checks and structural checks, a rule-based design consultant and analysis method optionally checks of the actual synthesis and physical implementation of the design as well as timing. The design consultant optionally incorporates a synthesis engine that maps to a technology specific vendor library. This enables timing and area analysis features that identify, for example, high-density areas and timing critical paths. It optionally provides a physical prototype of the design that can be checked for a wide range of physical design issues ranging from early congestion analysis, area analysis, long wire detection, and timing based on the physical prototype. The design consultant may also allow for reading in a PDEF file generated by another floorplanning or placement tool. This provides the availability of iterations between tools, or even the use of another floorplanner to generate the floorplan that is to be analyzed by the design consultant. Combining physical, timing, and structural checks provides a more accurate and useful diagnosis for circuits compared to traditional rule checkers.

The design consultant may provide textual and/or graphical reports to help organize and view the results of rule analysis. Cross-probing allows a rule to highlight the cells of interest in all views of the design. When issues are detected, the report has access to generate schematics and/or floorplans, highlight or color cells of interest, and provide links back to the original HDL.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is an example process flowchart for generating logic objects.

FIG. 2 is an example process flowchart for processing RTL using objects.

FIG. 3 is a flowchart of an example integrated circuit design method.

FIG. 4 is a block diagram of an example design consultant according to an embodiment of the present invention.

FIG. 5 is a screenshot of an example report created by a design consultant according to an embodiment of the present invention.

FIG. 6 is a flowchart of an example rule-based design analysis method according to an embodiment of the present invention.

FIG. 7 is a screenshot of an example graphical user interface for a design consultant according to an embodiment of the present invention.

FIG. 8 is an illustration of a block having a large bit-width multiplexer.

FIG. 9 is an illustration of a block having a large bit-width arithmetic structure design.

FIG. 10 is an illustration of a large multiplexer tree.

FIG. 11 is an illustration of a cone of logic.

FIG. 12 is an illustration of major sub-blocks having a large number of cell pins per area.

FIG. 13 is an illustration of a single built-in test source for multiple RAMs.

FIG. 14 is an illustration of congestion resulting from a single bus address and data feeding multiple RAMs.

FIG. 15 is an illustration of an IC chip with a global controller.

FIG. 16 is an illustration of an IC chip with global configuration registers.

FIG. 17 is an illustration of a register with high fan-in and fan-out.

FIG. 18 is an illustration of a global multiplexer tree.

FIG. 19 is an illustration of a local multiplexer tree.

FIG. 20 is an illustration of an IC chip with a global register.

FIG. 21 is an illustration of an IC chip with duplicate registers.

The present invention will be described with reference to the accompanying drawings. The drawing in which an element first appears is typically indicated by the leftmost digit(s) in the corresponding reference number.

### DETAILED DESCRIPTION OF THE INVENTION

Table of Contents

| I. | Integrated Circuit Design Overview | |
|---|---|---|
| | A. | Front End: RTL and Synthesis |
| | B. | Back End: Place and Route |
| II. | Advanced Optional Processing Features, Abstract Representations of | |
| | RTL, and Physical Synthesis | |
| | A. | Standard Cell Objects |
| | B. | Logic Objects |
| | C. | Memory and IP Blocks |
| | D. | Hierarchies |
| | E. | Hard Objects, Pseudo Hard Objects, and Soft Objects |
| III. | Example Environment for RTL Processing with Abstract | |
| | Objects | |
| | A. | Generation of Libraries of Logic Objects |
| | B. | Physical Synthesis Using Libraries of Logic Objects |
| IV. | Rule-Based Design Consultant | |
| | A. | Rule Analysis and Reporting |

| | |
|---|---|
| 1. | Rules and Information Databases |
| 2. | Congestion Analysis |
| 3. | Design Consultant and Method |

| | |
|---|---|
| B. | Graphical User Interface |
| C. | Cross-Probing Within the Design Consultant |

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

I. Integrated Circuit Design Overview

Integrated circuits are designed using computer-based hardware description languages (“HDLs”). Several types of HDL exist, including but not limited to verilog, VHDL, systemC, and SystemVerilog. HDLs can be used at a variety of design levels, including register transfer level (“RTL”), behavioral, and electronic system level (“ESL”). Although the present application will describe the invention with reference to RTL code, a person of ordinary skill in the art will recognize that any type of logic source code (e.g., any HDL), at any design level, may be used.

EDA tools are typically classified as front-end or back-end tools. Front-end EDA tools typically operate on HDL code and/or abstract representations of functions associated with the HDL code. Conventional front-end EDA tools attempt to optimize the HDL code and/or the abstract representations. For example, synthesis and technology mapping, functional verification, and/or initial timing analyses can be performed.

Conventional front-end EDA tools utilize rough estimates or statistical estimations of characteristics of the eventual integrated circuit design. The characteristics can include timing and/or power consumption. Because of the rough estimates, conventional front-end processes are less than ideal, but can be useful, nevertheless, because they can identify some problems at an early stage.

During back-end processing, the HDL code and/or abstract objects representative of the HDL code are converted to a layout design of the integrated circuit. A typical layout design includes millions of gates and associated interconnections. The back-end processing arranges and re-arranges the gates in an attempt to obtain desired operational characteristics. This is often referred to as a “place and route” operation. Because of the sheer number of gates and interconnections, conventional back-end processing typically takes days to converge on a solution.

In many cases, the initial back-end operation is unable to obtain or converge on a design that meets the design criteria (i.e., desired operational characteristics). For example, the circuit may consume more power than called for, or may have internal gate or wire delays, which prevent proper operation. When this occurs, designers must revise the HDL code and repeat the front-end and back-end processes. EDA thus tends to be an iterative process, which may take days, weeks, or months to converge on a workable design.

Additional features related to front-end and back-end processing are provided below.

A. Front End: HDL and Synthesis

Integrated circuit designers write desired functionality into HDL code. During front-end design, the HDL code is converted, or synthesized, to a gate-level list (“gate-level netlist”) of transistor gates (“gates”) and interconnections. Synthesis typically includes optimization of the HDL code, such as by elimination of redundant terms. Synthesis can also revise the structure of the HDL code to improve performance.

Some conventional synthesis tools use models for certain types of logic, such as adders and multipliers. Conventional systems do not, however, utilize the models for placement operations and do not use actual physical information in the models (e.g., actual wire lengths and gate delay information). Thus, gate-level netlists generated by conventional synthesis systems typically require extensive additional optimization and iterations at the back end.

B. Back End: Place and Route

During back-end processing, the gate-level netlist is mapped onto an integrated circuit design. This includes iteratively rearranging the placement of the gates, and iteratively routing and re-routing interconnections so that the circuit meets given timing and power constraints. In addition to moving the gates around to minimize interconnection lengths (place and route), back end operations can include sizing and/or buffering. Sizing refers to replacement of one gate with another functionally equivalent gate to provide different drive. Because of the sheer number of gates involved in typical designs, optimization procedures that are executed in the back end are typically very time consuming and computationally demanding. The back-end process also involves the floorplanning of macros, black boxes, and user defined blocks, as well as the placement of I/O pads. This process is typically very difficult, requiring a lot of manual intervention, and is generally not in the skill set of a typical front-end designer.

II. Advanced Optional Processing Features, Abstract Representations of RTL, and Physical Synthesis

In order to reduce the work required during back end processing, groups of associated gates are optionally represented as objects. The objects represent functionality encoded by the HDL. Traditional back-end optimization operations, such as, and without limitation, logic optimization, floorplanning, placement, and/or routing operations can be performed on the objects at a high level by the front-end designer. These optimization operations done at a high level of abstraction reduce the work required in the back end and thus reduce the overall time required to convert HDL code to an integrated circuit design.

For example, Tera Systems, Inc., of San Jose, Calif., has developed logic objects (e.g., Tera Systems' TeraGate™), that provide realistic high-level representations of integrated circuit building blocks. Tera Systems, Inc. has also developed a number of processes for optimizing design layouts of objects, including logic objects (e.g., Tera Systems' TeraForm™). The realistic high level representations and associated processes allow for more accurate front end and back end optimizations at a high level of abstraction. As a result, the amount of work performed during back-end processing is significantly reduced.

Logic objects represent HDL code, or portions thereof. Each logic object typically represents multiple gates, sometimes thousands of gates. Logic objects can represent, for example, AND functions, OR functions, and more complex functions such as adders, multipliers, multiplexers and bit-stacked objects such as a multi-bit register. The logic objects serve as high-level or abstract representations of the components of the integrated circuit design.

An important feature of the logic objects is that they include actual gate level physical information associated with the underlying gates. The physical information can include structural information for the underlying gates (e.g., net count, pin count, standard cell count, routing and blockage information), placement-based wire-load models for wires between gates, related placement information for gates included in the model, and actual timing and power information for the gates. The gate level physical information is obtained from integrated circuit fabrication facilities. Libraries of logic objects can be generated to incorporate various design features that are supported by a fabrication facility.

Inclusion of physical information in the logic objects, including use of placement-based wire-load models, and associated processes, are described in U.S. Pat. Nos. 6,145,117 and 6,360,356B1, and U.S. patent application Ser. No. 10/040,852, all titled, “Creating Optimized Physical Implementations from High-Level Descriptions of Electronic Design,” all of which are incorporated herein by reference in their entireties.

In operation, during front-end processing, HDL code, or portions thereof, is automatically converted to logic objects and other optional objects. The objects are then placed and routed during front-end processing.

Advanced front-end operations are performed on hundreds or thousands of logic objects and other types of optional objects, rather than the millions of gates that are operated on during back-end processing. Advanced front-end operations for processing logic objects include floorplanning, place and route operations, which take into account the actual physical information of the underlying circuitry that is represented by the logic objects.

Advanced front-end processing of objects essentially move back-end operations to the front-end. At the same time, the product automates these back-end operations to make the tool usable and accessible to conventional front-end designers, without requiring the years of experience that conventional back-end tools require for effective usage. As a result, design problems are more likely to be identified early on by the actual system designers instead of late in the design flow by the back-end engineering team. In addition, when the advanced front-end process converges on a place and route solution for the objects, the back-end process simply has to place and route gates within the area that was assigned to corresponding logic objects. In other words, there is generally no need for iterative back-end place and route operations to be performed on the overall design. Thus, back-end processing can typically be performed in a single pass.

When the advanced front-end synthesis process is performed with actual physical information, the synthesis operation is referred to herein as a “physical synthesis” operation. The front-end physical synthesis operation generates a netlist of objects rather than a gate level netlist. The netlist of objects includes gate level netlist information associated with each object that is needed during back-end processing. Since the objects have been placed during front-end processing, back-end processing can focus on detailed placement of the gates within each object. This substantially reduces the amount of work performed during back-end processing.

The objects optionally include information that maps the objects back to the corresponding RTL code. As a result, debugging of a design, at any level, can be mapped back to the corresponding RTL code.

RTL code can be converted into a variety of types of objects, examples of which are provided below. The invention is not, however, limited to the examples provided herein. Based on the description herein, one skilled in the relevant art(s) will understand that other types of objects can be utilized, and that objects may be of multiple types.

Objects, such as logic objects, allow the RTL code to be represented at a level of abstraction that is above a gate level netlist. The objects can be manipulated during front-end processing using fewer resources (e.g., computational resources and/or manpower resources) than what is required to manipulate corresponding gate level components.

For example, placement operations are optionally performed on the objects. Front-end placement operations provide placement information for the objects. During back-end processing, gates within the abstract objects are placed within the areas assigned to corresponding objects. Front-end operations performed on abstract objects are relatively fast because there are fewer objects to manipulate, compared to the number of gate level components in a netlist. The high-level operations thus reduce the overall time to reduce RTL code into an integrated circuit design.

A. Standard Cell Objects

Some portions of RTL code provide support functions for other features. Support functions can include, without limitation, glue logic, timing logic, control logic, memory logic, interconnection, etc. The term glue logic is used to broadly refer to features such as, and without limitation, buffers and/or interfacing functions. RTL code that provides such supporting functions is optionally represented as objects referred to herein as standard cell objects. A standard cell object may be an abstraction representing one or more transistors or gates, such as AND gates and OR gates. Standard cell objects can also include relatively simple sequential elements such as flip-flops and latches.

A standard cell object may include information such as, and without limitation, function(s) performed by the standard cell, area required to implement the standard cell, interconnections with other objects, and/or identification of the line(s) of RTL code that are associated with the standard cell.

B. Logic Objects

Some portions of HDL code are typically directed to more complex logical functions, such as arrayed or high fan-in AND operations and OR operations, multiplying operations, multiplexing operations, and more complex sequential operations (e.g., shift register, register file). Such HDL code is optionally represented by what is referred to herein as TeraGates™ or logic objects. A logic object is an abstraction that typically represents multiple gates and/or standard cells.

Logic objects include actual gate level physical information associated with the underlying gates, as described above. Logic objects also include information such as, and without limitation, function(s) performed by the logic object, area required to implement the logic object, interconnections with other objects, etc.

C. Memory and IP Blocks

A typical integrated circuit design includes one or more memory blocks and/or one or more proprietary blocks. Proprietary blocks are often referred to as intellectual property blocks or IP blocks. Memory blocks and proprietary blocks are optionally represented as objects during front-end processing.

D. Hierarchies

Designers often write RTL code with hierarchies, in which functions are grouped together according to some principle, such as according to an associated engineering group responsible for the code, and/or according to functions performed by the associated code. RTL functional hierarchies, and/or other hierarchies described below, are optionally maintained during synthesis.

In the actual layout of the integrated circuit, it may make more sense to re-group components from one hierarchy to another in order to optimize timing, routing, area, and/or power requirements. In some situations, therefore, functional RTL hierarchy designations are dissolved or ignored, in whole or in part, during front-end and/or back-end processing. The underlying logic encoded in the RTL is not ignored, only the grouping of logic functions.

E. Hard Objects, Pseudo Hard Objects, and Soft Objects

Objects are optionally defined as hard objects, pseudo hard objects, or soft objects. Hard objects have fixed shape constraints. Pseudo hard objects have one or more discrete shape constraints. Soft objects, on the other hand, have no shape constraints.

Standard cell objects, memory, and IP blocks typically have fixed size and/or shape and are thus generally referred to as hard objects. Logic objects and hierarchies typically have variable size and/or area constraints and are thus considered soft objects. Hierarchies (logic functions or clusters) which contain hard and/or pseudo hard objects are considered pseudo hard objects.

III. Example Environment for RTL Processing with Logic Objects

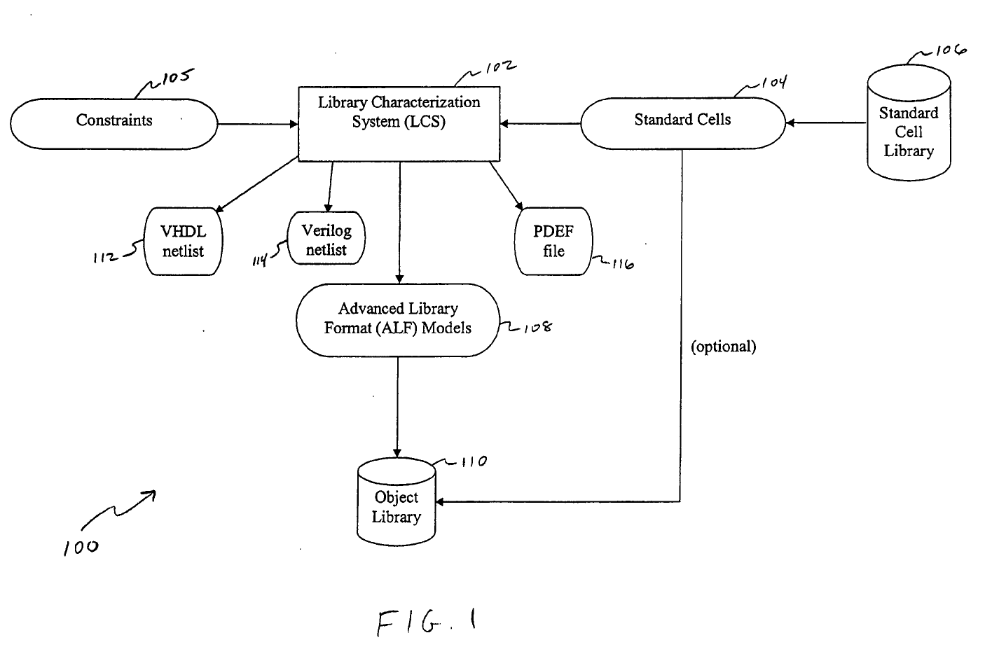

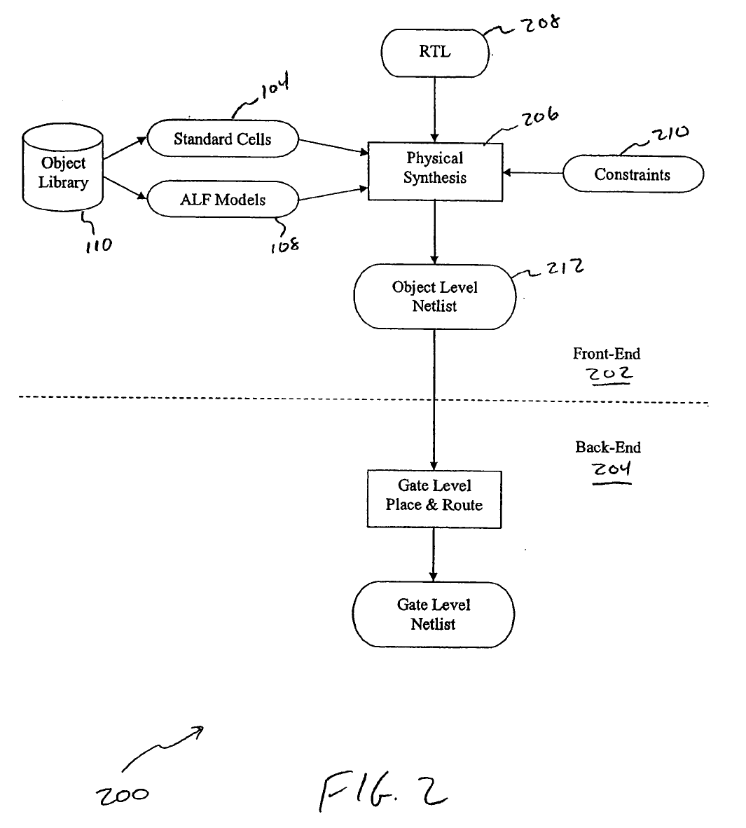

FIGS. 1 and 2 are example process flowcharts according to embodiments of the invention for processing RTL using logic objects. The invention is not, however, limited to the examples of FIGS. 1 and 2. Based on the description herein, one skilled in the relevant art(s) will understand that the invention can be implemented with other process flowcharts.

A. Generation of Libraries of Logic Objects

FIG. 1 is a process flowchart 100 for generating logic objects. A library characterization system (“LCS”) 102 receives standard cells 104 from a library of standard cells 106. The standard cells 104 typically include a plurality of standard logic cells such as, for example and without limitation, AND cells, OR cells, flip-flops, and the like. The standard cells 104 are optionally obtained from an integrated circuit fabrication facility, wherein the standard cells 104 incorporate process-dependent features of the fabrication facility, including timing, physical area, and power information.

The LCS 102 also receives constraints 105. The constraints 105 include gate level physical information for implementing the standard cells 104. The constraints 105 are typically associated with a fabrication facility and, more particularly, with an implementation technology of the fabrication facility. For example, and without limitation, the constraints 105 are optionally tailored for speed, power consumption, and/or process, voltage, and/or temperature operating ranges.

The LCS 102 generates, from standard cells 104 and in accordance with constraints 105, abstract models 108, such as, for example, advanced library format (“ALF”) models 109, VHDL netlist 112, Verilog netlist 114, and PDEF file 116. VHDL netlist 112 and Verilog netlist 114 may be used to provide a complete gate-level netlist to back-end tools. This precludes the need to run a separate gate-level synthesis in order to provide a full netlist to the back-end. PDEF file 116 includes relative placement information, which can be used to drive the detailed placement of back-end tools. This improves overall correlation with back-end tools. The abstract models 108 represent, for example and without limitation, one or more of the standard cells 104, and/or more complex logic, such as multipliers, multiplexers, Boolean logic or glue logic, and/or mega functions such as large adders, that are constructed from multiple standard cells 104.

The abstract models 108 include a variety of information derived from the physical gates needed to implement the logic object, such as pin information associated with the gates, interconnection information between the gate pins, detailed timing information, detailed area information, and/or other physical information, such as placement-based wire load models.

The abstract models 108 can also include information provided as part of the characterization process, such as bit widths, architecture, and constraints used to build the object.

The abstract models 108 are stored in an object library 110. The object library 110 optionally includes one or more standard cells 104, with or without physical information.

The library 110 is optionally generated, in whole or in part, in advance of need and/or on-the-fly. The libraries can also contain a description of the relative placement of gates within the object, which can be used to drive downstream back-end implementation tools. Multiple libraries 110 can be generated for different technologies using different sets of constraints 105.

B. Physical Synthesis Using Libraries of Logic Objects

FIG. 2 is a process flowchart 200 for synthesizing HDL code using logic objects. The process flowchart 200 includes a front-end processing section 202 and a back-end processing section 204.

A physical synthesis module 206 receives HDL code 208, abstract models 108 from object library 110, and constraints 210. The constraints 210 are for the design in process and are not the same as constraints 105 in FIG. 1. The physical synthesis module 206 optionally receives one or more standard cells 104.

The physical synthesis module 206 synthesizes the RTL code 208 using the ALF models 108 and the constraints 210. The physical synthesis module 206 optionally uses one or more standard cells 104. Physical synthesis includes traditional RTL synthesis as well as floorplanning, placement, and/or routing of the objects using physical information associated with the ALF models 108.

During synthesis, the physical synthesis module 206 generates instances of the ALF models 108 (i.e., logic objects) as needed to represent functionality encoded in the HDL 208. Each instance of a logic object retains most, if not all, of the information originally contained within the corresponding ALF model 108.

Each instance of a logic object is populated with an identification of the portion(s) of the RTL code 208 associated with the instance of the logic object. Each instance of the logic object is further populated with interconnection information to other objects. Thus each instance of a logic object includes gate level netlist information, timing and area information, and mapping information to corresponding RTL code. The RTL mapping information allows the objects to be mapped back to the RTL for troubleshooting and/or other purposes.

During physical synthesis, the physical synthesis module 206 optionally performs one or more conventional synthesis operations on the RTL code 208. Since each object represents multiple gates, manipulations of the objects takes considerably less computer processing time than would be required to perform similar manipulations of the individual gates at the back end.

During physical synthesis, the physical synthesis module 206 also optionally performs one or more unconventional synthesis operations on the RTL code 208, such as optimizing stacked logic. Stacked logic can be, for example, a bus of data lines that are ANDed together. Rather than generating a large number of small individual AND gates at the gate level, a single stacked, multiple input AND gate is used. The single stacked AND presents a single object to the tools, substantially improving the runtime and capacity. All of the process operating at this higher level of abstraction take advantage of this more advanced and efficient data model.

The physical synthesis module 206 outputs an object level netlist 212, which includes instances of logic objects. Each logic object includes associated gate level netlist information. The object level netlist 212 is passed to the back-end process 204, where place and route operations are performed on the gate level netlist information associated with the logic objects. This gate level netlist can be provided, for example, by LCS 102.

IV. Rule-Based Design Consultant

A rule-based design consultant based on a physical layout and having semantic and structural capabilities can optionally be used at any point during the design process. A design consultant that considers the physical layout goes beyond simple limiting and structural checks and adds checking of the actual synthesis and physical implementation of the design. Utilizing the physical information can identify timing, physical and structural issues that will have a direct impact on the synthesis, floorplan, and/or physical implementation of the design. Additionally, such a consultant may link source RTL code to technology-specific checking through synthesis to physical floorplanning and placement. Linking these issues back to the source RTL allows front end designs to benefit from the added accuracy and capabilities of a full synthesis and optimization environment. Although the design consultant will be described with references to logic objects, one of skill in the relevant art will recognize that the design consultant may also be used in conjunction with gate level objects and/or standard cells.

A. Rule Analysis and Reporting

1. Rules and Information Databases

Three types of rule analysis may be performed on an IC design. The first type is semantic analysis. Semantic analysis involves language-based rules. These rules typically check a parsed database to identify coding style issues, such as naming conventions and file organization. Semantic analysis may also determine whether the HDL code is synthesizable.

Structural analysis is another type of rule analysis. As the name implies, structural analysis operates on structural relationships in a net list and occurs after synthesis. Structural analysis reviews structural issues, such as, for example, hierarchies, clock domains, and testability. Structural analysis can also check for signs of congestion, such as multiplexer trees, large structures, and high pin densities. Tools may also provide further delineation of the structure checks, which may include but are not limited to testability checking, simulation checking, and synthesizability checks. For the purpose of this document, all of the above-mentioned checks are considered to be part of the general structural analysis heading.

Another type of rule analysis is implementation analysis. Implementation analysis includes, for example, constraint processing and timing analysis. Implementation analysis operates on a design database and can analyze methodology issues, such as constraints, timing, and routability. Examples of constraints are whether the IC has any undefined and/or gated clocks or cross clock-domain timing paths. In addition, the rule-based design consultant can make sure the circuit is receiving all the timing information, such as clock definitions and I/O constraints. Examples of routability analysis are whether there are any top-level snake paths, unregistered output, high fan-in or fan-out cells, or high congestion areas. Implementation analysis can also check to verify that specific cells will fit within a given area. More advanced implementation checking includes examining the physical floorplan and place and route to identify congestion, timing, and routability issues. The physical implementation is used to generate congestion maps and analysis based on global routing and actual pin/cell locations.

Analysis and optimization of the RTL code based on semantic, structural, and physical checks offers significant advantages over tools that analyze at synthesis levels or without physical checks. The highest degree of flexibility in an IC design is at the abstract RTL level, before the design has been set into silicon. Physical RTL optimization relieves downstream burdens at the back end. Additionally, RTL optimization creates a homogeneous design style from a heterogeneous customer and designer base.

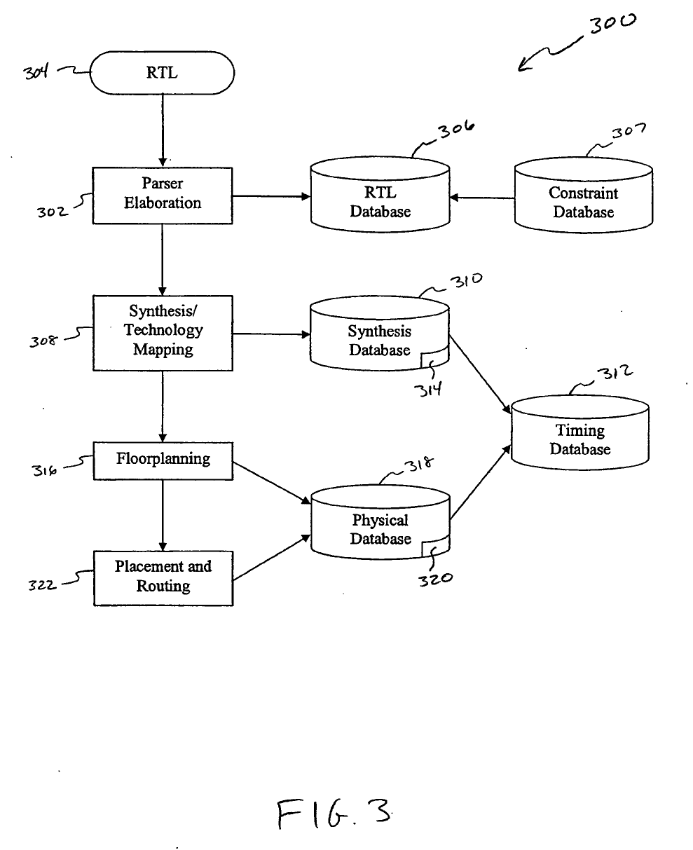

FIG. 3 is a flowchart of an example IC design method 300. Method 300 begins with step 302, performing parser elaboration on input RTL code 304. Step 302 produces an RTL database 306, also referred to as a logical database. Although the present invention will be described as using logic objects such as TeraGates™, one of skill in the relevant art(s) will recognize that standard cells and/or gate-level objects may also be used without departing from the spirit and scope of the present invention.

RTL database 306 is a parsed database reflecting the original RTL, and offers a structural and connectivity model of the IC design. RTL database 306 may include information concerning, among other things, the type and number of objects and/or cells in the IC design; connectivity; macros included in the design; sequential series objects, such as latches; ports, including inputs, outputs, and connections between the ports; and/or hierarchies in the design. RTL database 306 may include information from a constraint database 307. Constraint database 307 is typically produced by the system design team based on chip level requirements. Constraint database 307 may include, for example, I/O delays; I/O libraries; clocks; and/or clock rate and cycle path exceptions.

After RTL database 306 is produced, method 300 proceeds to step 308, performing synthesis and technology mapping. One of skill in the relevant art(s) will recognize that synthesis may be performed separately from technology mapping. Synthesis and technology optimizations often reduce long logic-level paths, with significant impact on timing. Without this type of optimization, false or misleading violations may be reported by a rule checker. Further, synthesis flags and switches provide detailed wire estimations compared to simpler levels-of-logic type checks, and are important when deciding whether the source RTL needs to be changed. Step 308 produces a synthesis database 310, which in turn provides information to a timing database 312. Synthesis database 310 includes a synthesis constraint database 314.

Synthesis database 310 is a fully mapped technology-dependent database complete with, for example, SDC constraints and full timing and area analysis. Synthesis database 310 may include information about, among other things, area; net capacitance; pin capacitance; cell constraints, such as maximum capacitance or maximum fan-out; leakage power and/or dynamic power; the synthesis hierarchy, architecture selection; and/or timing. Synthesis database 310 also includes an optimized netlist.

Method 300 then proceeds to step 316, in which floorplanning is performed. Step 316 produces physical database 318. Physical database 318 includes information about, among other things, routing-based timing;
physical data, such as cell and pin locations, net length between pins, net capacitance, number of horizontal and vertical nets and vias per metal layer, and/or congestion based on routing; array-based pin placement; physical floorplan, such as macro placement, I/O placement and/or hierarchy node placement; physical hierarchy; total area; and/or utilization. Physical database 318 also includes a physical constraint database 320. Physical database 318 may supply information to timing database 312.

Step 322 is the next step in method 300. In step 322, placement and routing is performed. Step 322 also contributes to physical database 318. The information included in physical database 318 enables more accurate timing and area analysis than synthesis database 310, and enables rule checking based on the physical design. Each of databases 306, 310, and 318 may include a constraint database (such as synthesis constraint database 314 and physical constraint database 320), a structural database, and a timing database based on information available at each processing level.

Steps 308, 316, and 322 may be performed in, for example, physical synthesis module 206 shown in FIG. 2. Method 300 may output a netlist, such as object level netlist 212 from FIG. 2.

2. Congestion Analysis

High congestion can slow down a circuit, and possibly result in negative slack on various paths. Negative slack means that the logic leading up to a register takes longer to run than it should. High congestion areas also can have significant routing and congestion issues that can cause a design to fail the implementation process, have signal integrity issues, or fail to fit in the prescribed physical package. Once a physical layout is obtained, the implementation can be analyzed for certain features which often cause congestion. Several examples of congestion are described below with respect to FIGS. 8-17.

FIG. 8 is an illustration of a block 800 having a large bit-width multiplexer 802. In the example of FIG. 8, multiplexer 802 is an 8:1 multiplexer. Signal buses 804 from registers 806 are input to multiplexer 802. If each of signal buses 804 is 128 bits wide, multiplexer 802 has a 1024-bit input. Large bit-width multiplexers such as multiplexer 802 represent a large number of signals coming together in a very small space. This can cause routing problems if there are not enough routing resources to implement all the connections to the multiplexer. Large bit-width multiplexers can be replaced with other equivalent logic by making changes to the source RTL.

FIG. 9 is an illustration of a block 900 having a large bit-width arithmetic structure design. Block 900 includes a 64-bit multiplier 902, which receives input from 4:1 multiplexer 904. Large bit-width arithmetic components such as multiplier 902 can require many signals to converge in one small area. This problem can be corrected in the source RTL by setting a proper bit-width size threshold for arithmetic components or breaking the offending operator into smaller components.

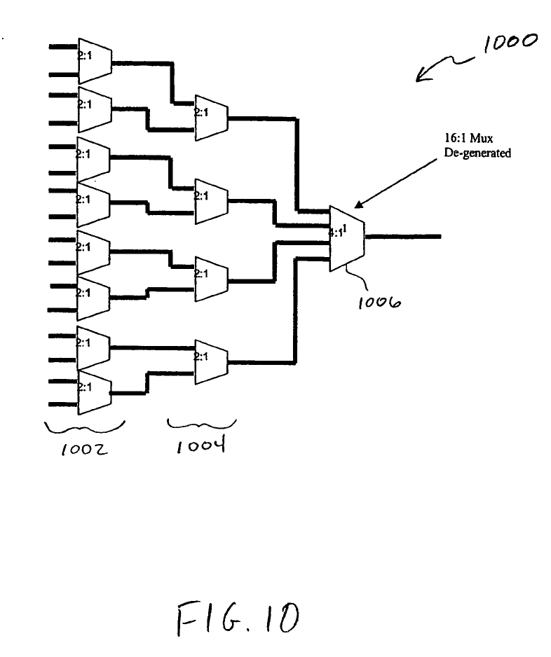

FIG. 10 is an illustration of a large multiplexer tree 1000. Multiplexer tree 1000 includes a set of 2:1 multiplexers 1002, a set of 2:1 multiplexers 1004 which receive input from multiplexers 1002, and a 4:1 multiplexer 1006 which receives input from multiplexers 1004. Multiplexer tree 1000 is thus a “degenerated multiplexer,” or a multiplexer broken down into smaller multiplexers. Cascading multiplexer structures (“prioritized logic”) or large degenerated multiplexers can also cause routing problems because the multiplexers are typically placed near one another and cause hot spots for routing.

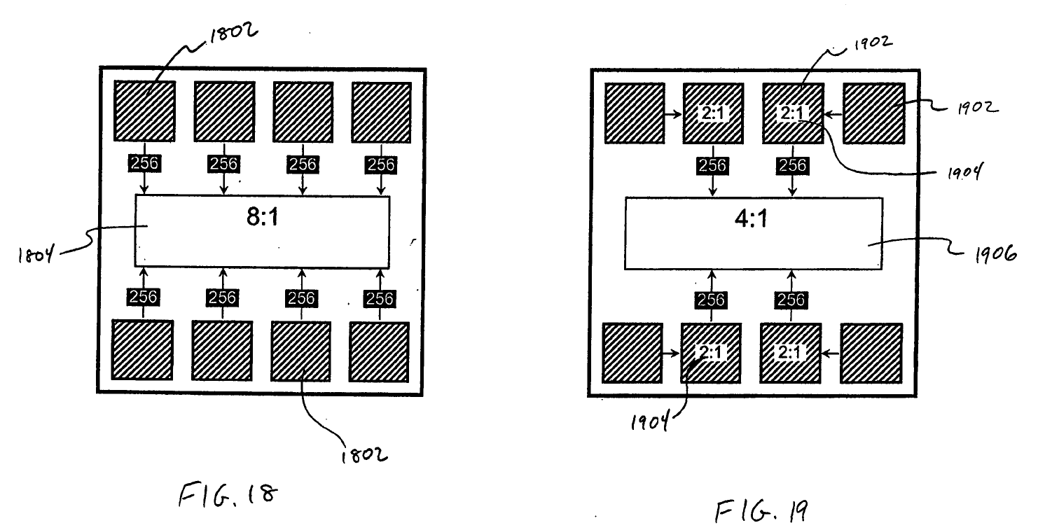

Multiplexer trees can be seen as having two different varieties. One variety involves global multiplexing, where signals from across a chip are multiplexed together. FIG. 18 is a block diagram of an example global multiplexer tree. In FIG. 18, each data source 1802 feeds directly into multiplexer 1804. Thus, if there are 8 data sources 1802, multiplexer 1804 needs to be an 8:1 multiplexer. The other variety of multiplexer trees involves local multiplexer trees, where the signals are in close proximity. FIG. 19 is a block diagram of an example local multiplexer tree. Data sources 1902 are combined locally through local multiplexers 1904. Data from multiplexers 1904 is then fed into multiplexer 1906. Detailed physical placement information is required to identify which type of tree is used, and also to define the proper solution to the problem.

This rule can also be used to drive automatic correction of the issue, once it is of a known type. Global multiplexers can be resolved by locally multiplexing close data sources. The location of the data sources is required in order to determine which multiplexers are close to each other. Local multiplexers can often be resolved by relaxing the utilization goals.

FIG. 11 is an illustration of a cone of logic 1102. Cone of logic 1102 represents the amount of functionality required to resolve an endpoint. If the cone has a large number of start-points associated with it, such as start-points 1104, this implies complexity that can be searched for with a rule checker. Such congestion could have timing as well as routing problems and hot spots.

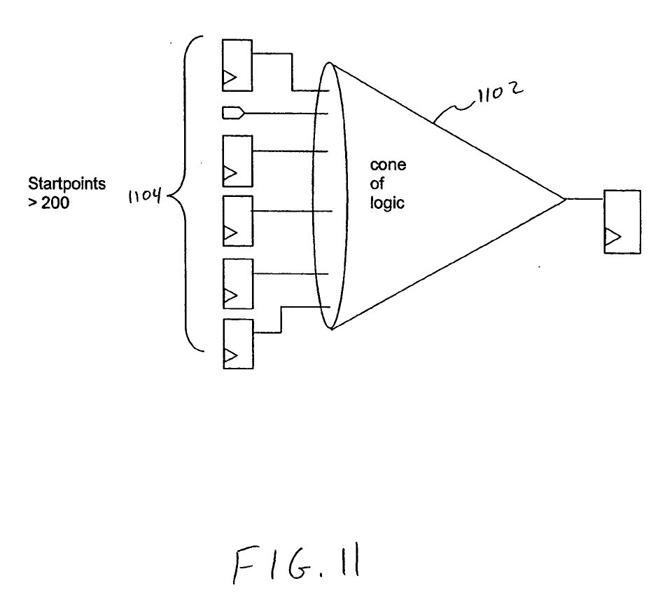

FIG. 12 is an illustration of major sub-blocks having a large number of cell pins per area. Sub-block 1202 includes several registers 1204. Each register 1204 includes a number of pins. Sub-block 1206 includes significantly more registers 1204 than sub-block 1202. Thus, sub-block 1206 has a higher number of cell pins per area than sub-block 1202. A major sub-block with a high pins-per-area count, such as sub-block 1206, indicates a potential routing problem for the entire block if the pins-per-area number is too high. This is a general congestion rule that points to an area of the design rather than to a specific cell. This problem can be fixed in the source RTL by re-partitioning the design.

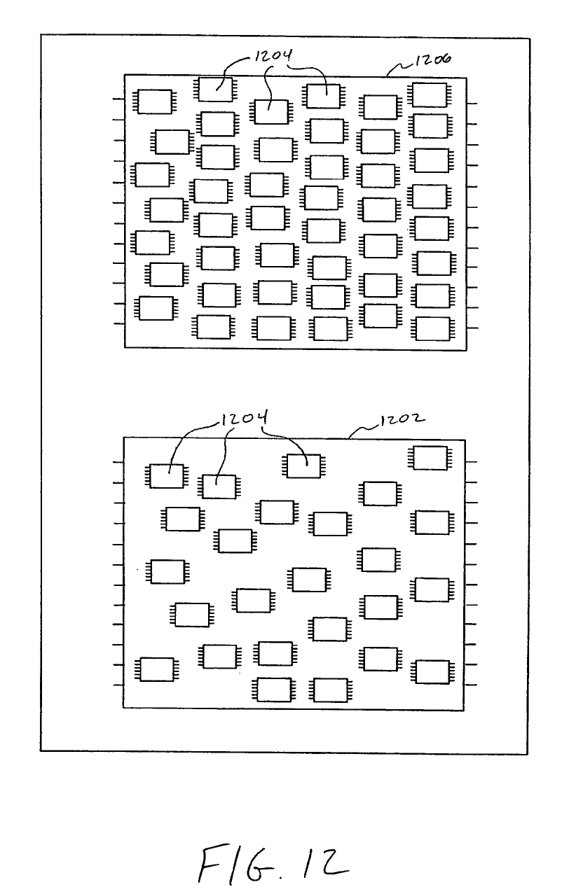

FIG. 13 is an illustration of a single built-in self test (“BIST”) source 1302 for multiple RAMs 1304. Bottlenecks 1306 occur when there is not enough room between obstructions for all signals to get through. Hot spots 1308 occur because of the large number of signals entering and exiting BIST source 1302. Early floorplanning, enabled by a physical implementation design checker, helps anticipate the relationship between the top level blocks in a design. Area can be traded for routability by duplicating critical function blocks in the source RTL.

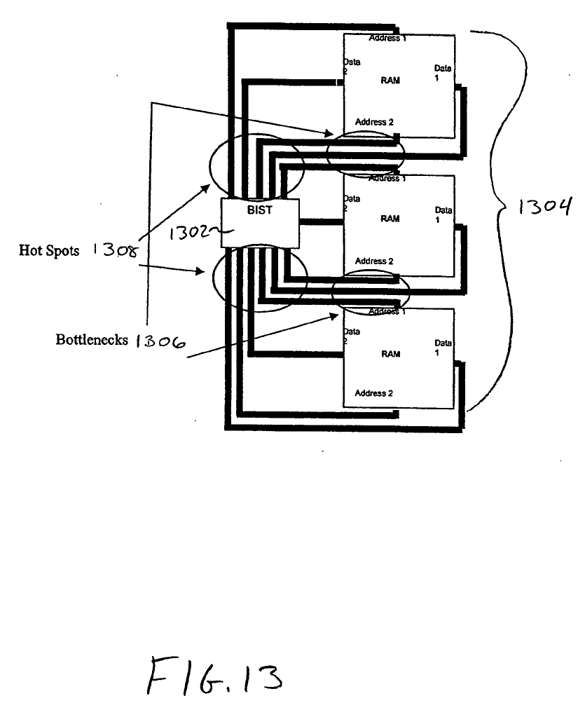

FIG. 14 is an illustration of congestion resulting from a single bus address 1402 and data 1404 with multiple RAMs 1406. Placing obstructions, such as RAMs 1406, too close together can leave insufficient space for routing a design, and bottlenecks 1408 may form. While this is primarily a placement issue, the solution might require rewriting the source RTL to relieve the routing stress.

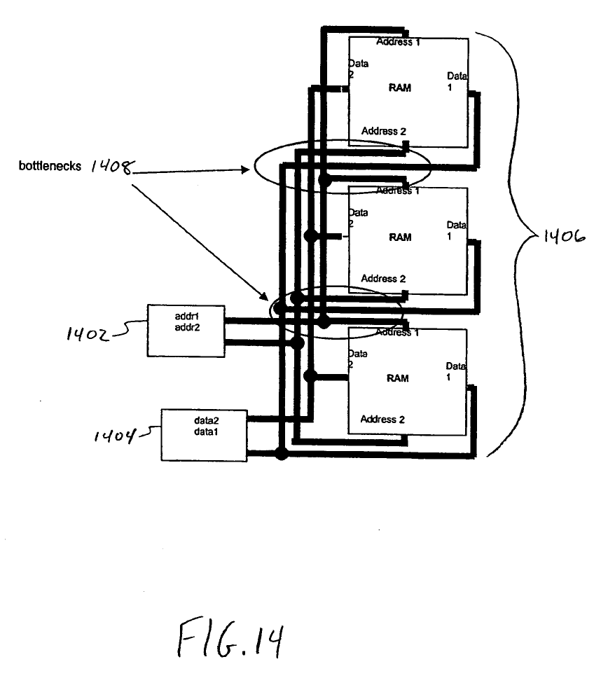

FIG. 15 is an illustration of an IC chip 1500 with a global controller 1502. Global controller 1502 controls registers 1504, 1506, 1508, 1510, and 1512, which are spread across the surface of IC chip 1500. Often, single controllers such as global controller 1502 are created and used throughout the chip to simplify design. However, global controllers can be slow since the signals span the entire chip. Routability is also difficult because the signal is so spread out. To reduce timing, the source RTL may need to be rewritten to duplicate the controller and localize it to each location where it is needed. Alternatively, the controller may be duplicated with a tradeoff of area.

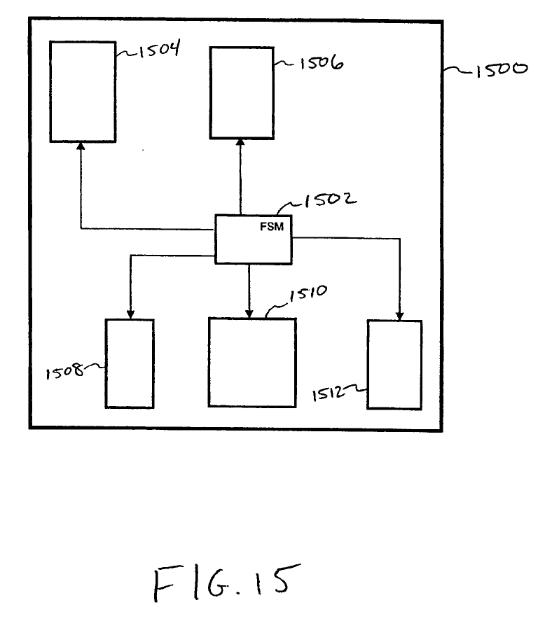

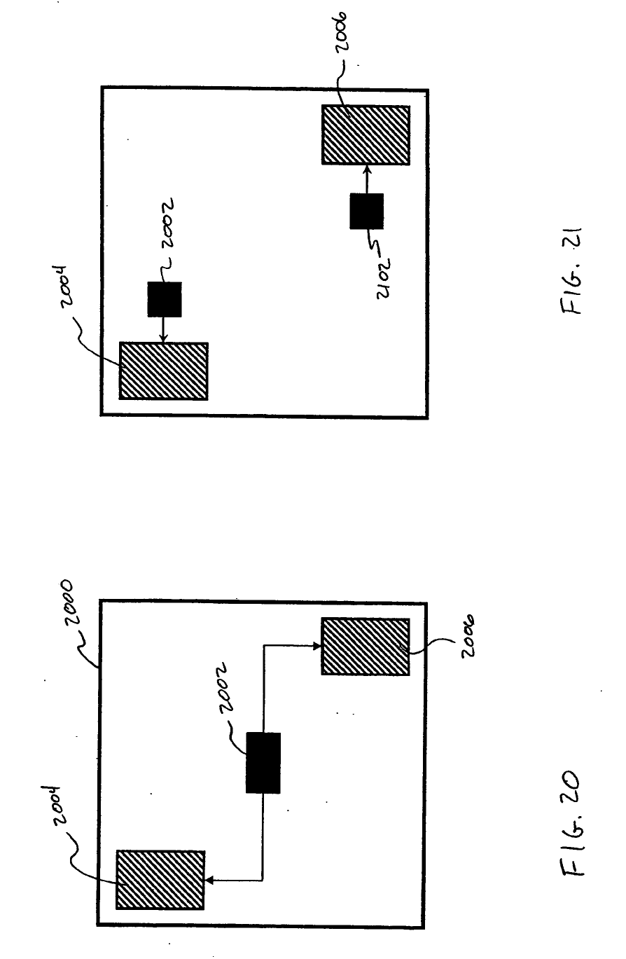

FIG. 16 is an illustration of an IC chip 1600 with global configuration registers 1602, 1604, 1606, 1608, and 1610. Global configuration registers are useful to minimize the amount of logic for a design, but can be problematic if control signals are routed across the chip and do not meet timing requirements. Using the physical locations of the cells can determine if this is a global register and not a high fanout cell. The course of action is distinctly different for each of these cases. For a global register, the source RTL can be rewritten to duplicate the configuration registers to improve routability and speed with a tradeoff of area. FIG. 20 is a block diagram of an IC chip 2000 having a global register 2002 connected to cells 2004 and 2006. If register 2002 is duplicated as register 2102, as shown in FIG. 21, the routing and timing can be reduced. For a high fanout cell, the user may wish to manually buffer the critical signals. Other tools cannot make this determination because they lack the physical knowledge required to determine the relative locations of the cells in question.

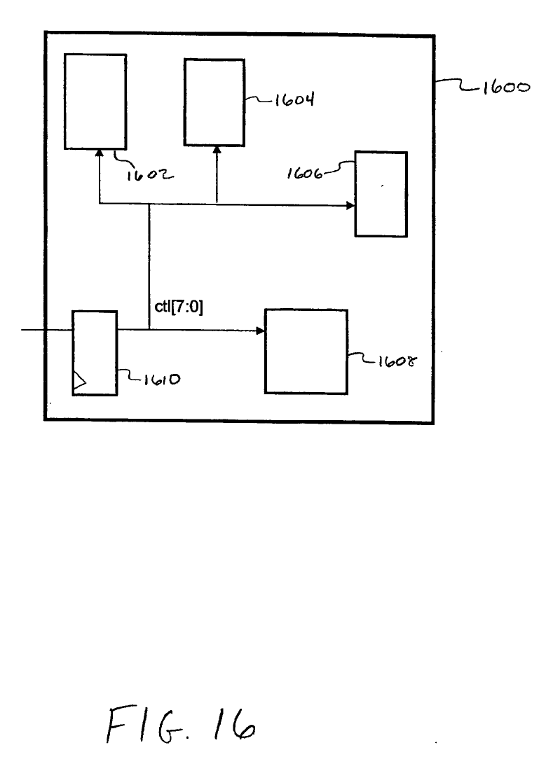

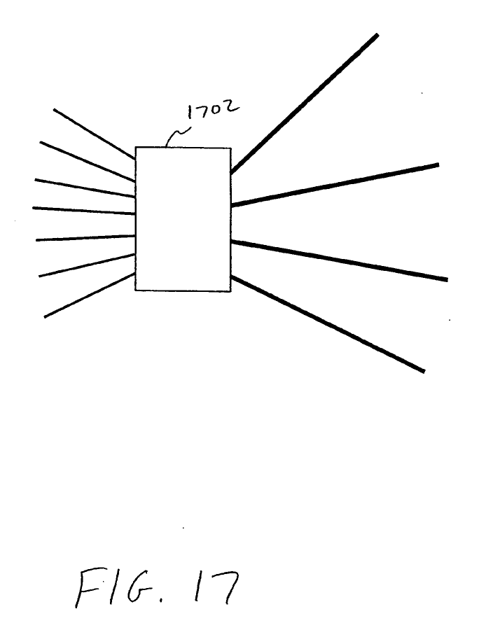

FIG. 17 is an illustration of a register 1702 having high fan-in and fan-out. High fan-in means that register 1702 processes a large amount of logic input. High fan-out means that register 1702 drives a large amount of logic as output. If a register, such as register 1702, has high fan-in, the register will take time to process each of the computations required. This takes time and may cause negative slack. If a register has high fan-out, the output signals probably spread out over the chip, which could cause delay. If high fan-in or fan-out is a problem, altering the source RTL may solve the problem.

Both global and local congestion issues, such as those described above, can be identified using physical implementation information, such as that in physical database 318 in FIG. 3. Global congestion refers to connections between different hierarchical blocks. Local congestion refers to congestion within a particular block, such as the number of pins in an area of a specific block. Further checking can utilize the global routing information and pin and cell location to better analyze the source of issues. Once these potential issues are identified, they can be corrected or mitigated through analysis of the related source RTL.

3. Design Consultant and Method

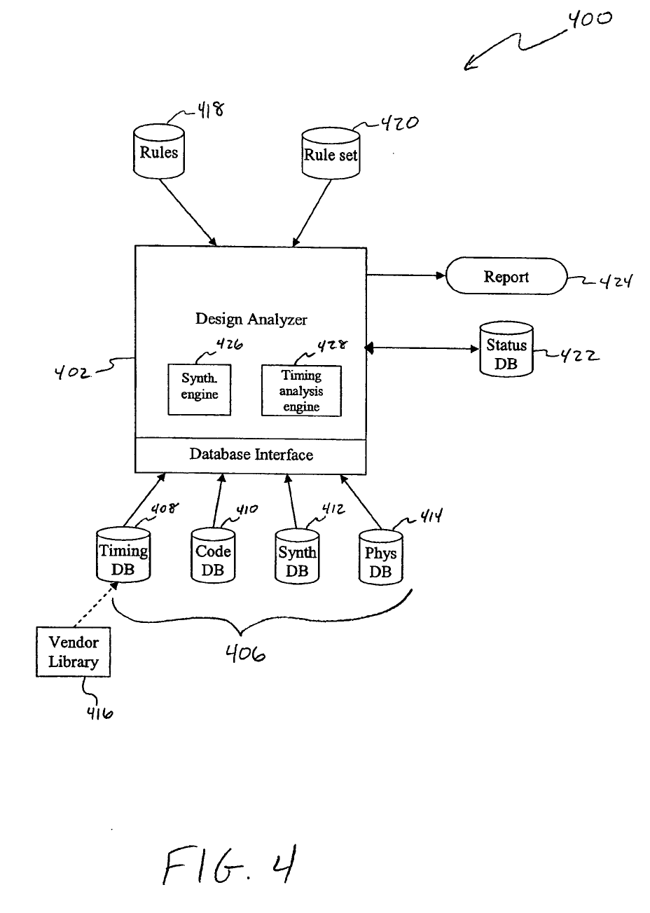

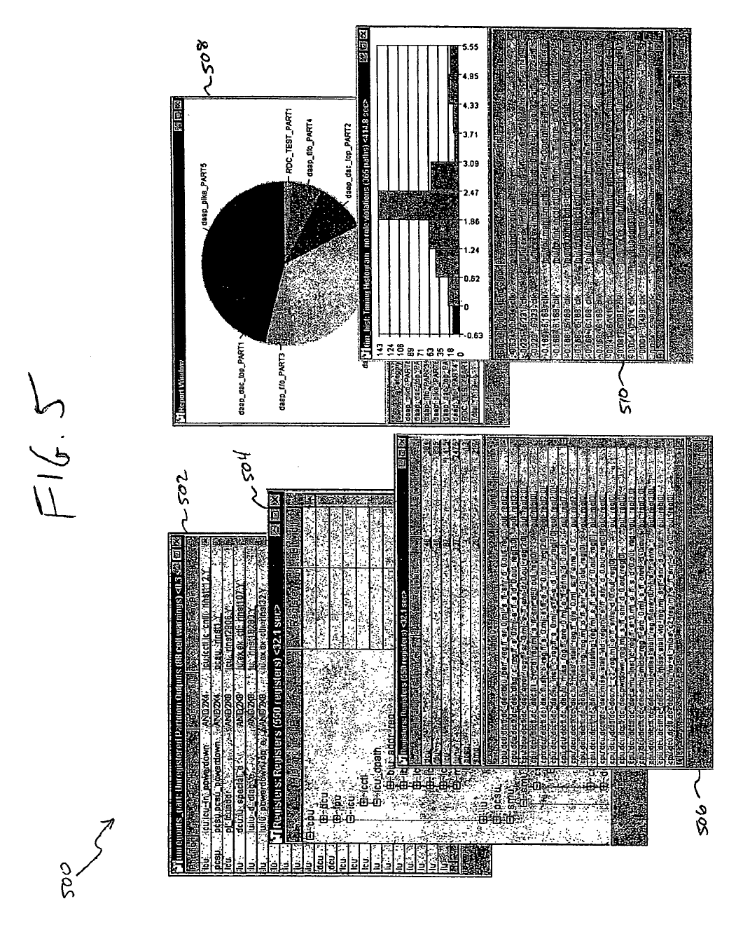

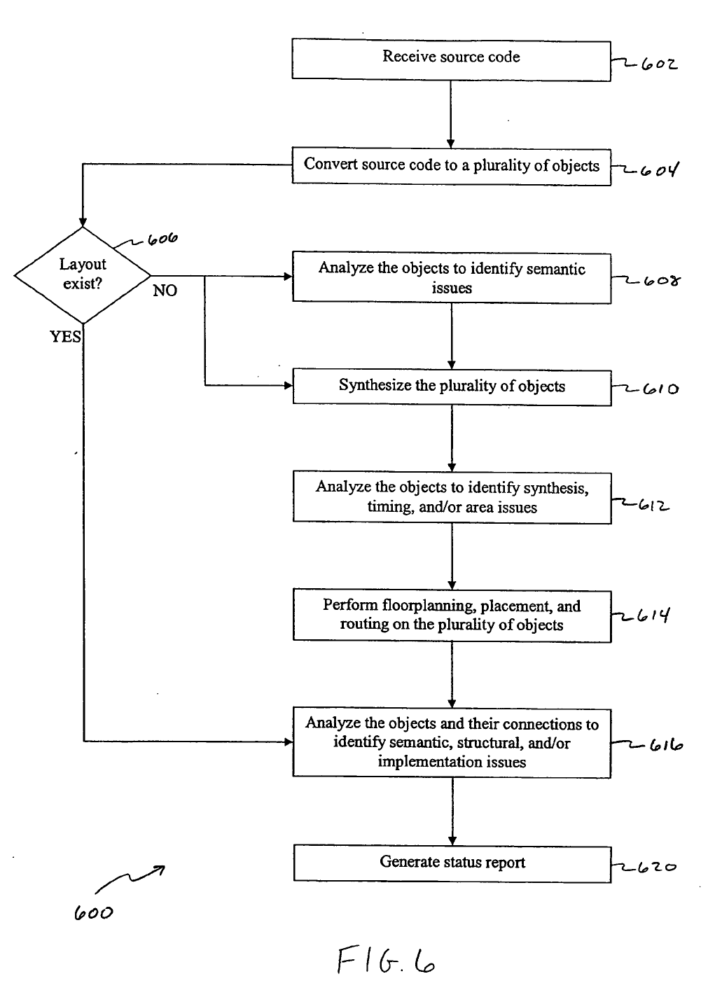

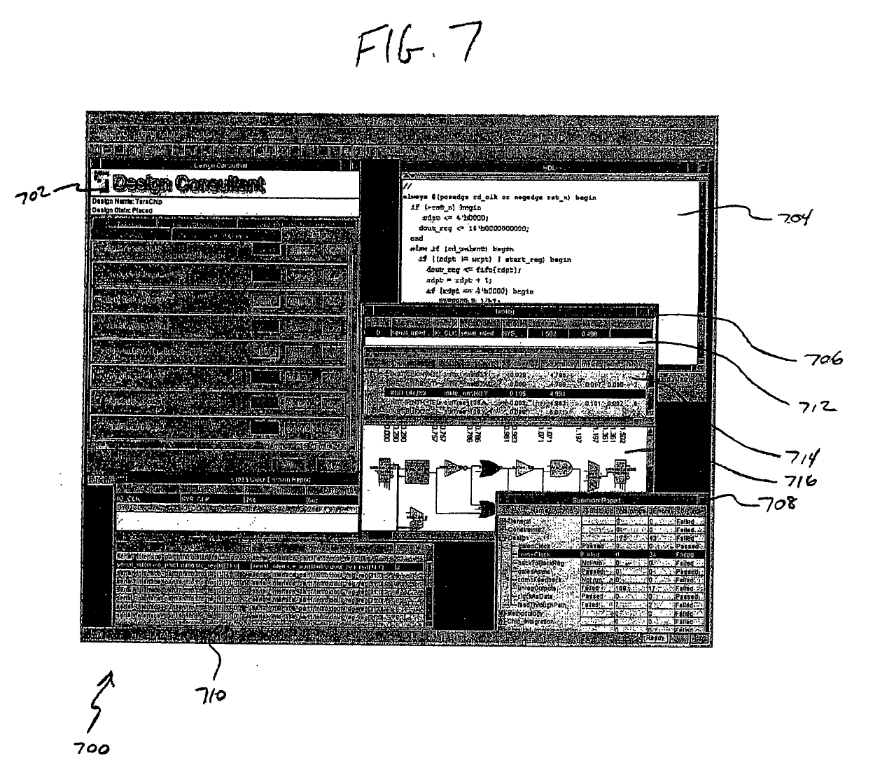

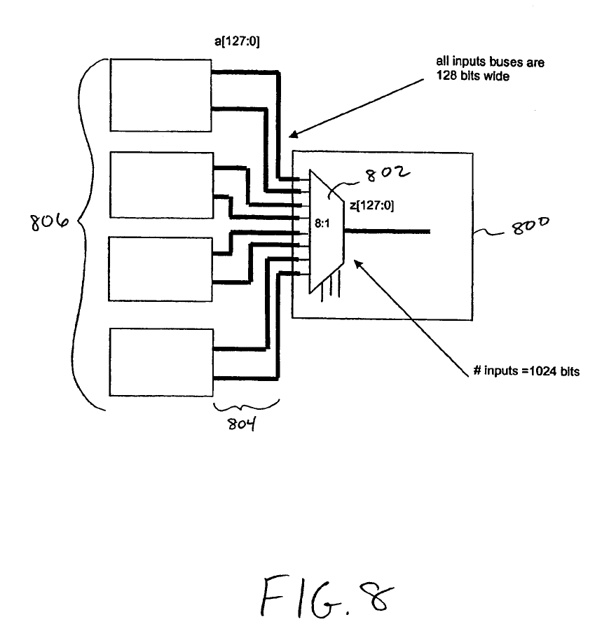

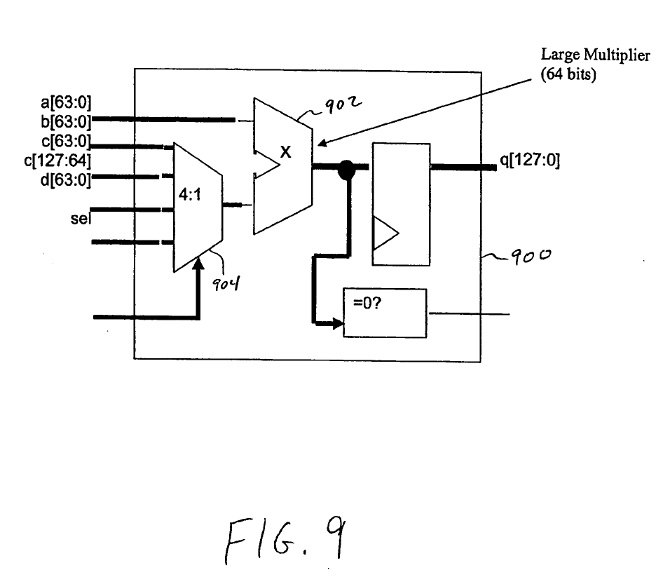

FIG. 4 is a block diagram of an example design consultant 400 according to an embodiment of the present invention. Design consultant 400 centers around a design analyzer 402. Design analyzer 402 includes a database interface 404, which interfaces with a plurality of databases 406. Database interface 404 may interface with plurality of databases 406 through, for example, a Tcl programming language. Tcl is a general purpose programming language originally designed to be used as an extension to other applications. Tcl is common across EDA tools. A graphical user interface (“GUI”) can be provided that runs on multiple operating systems. Java or a Tk toolkit, an extension of Tcl, provides a GUI library that could be used for this purpose. Tcl can also be used to configure applications in a variety of operating systems. Although design consultant 400 will be described with reference to Tcl and the Java toolkit, one of skill in the relevant art(s) will recognize that any type of programming and/or GUI design language or tool may be used without departing from the spirit and scope of the present invention.

Plurality of databases 406 includes a timing and constraint database 408, a source code database 410, a synthesis database 412, and a physical database 414. Timing database 408 may include information provided by an outside vendor 416. Design analyzer 402 also receives as inputs a rules database 418 and a rule set 420. The rules may be written, for example, in the Tcl programming language. Rules database 418 includes information about available rules. Rules database 418 may include rules written by a third party, such as a vendor. Rule set 420 includes the rules actually selected to be run. Design analyzer 402 may execute the rules by running an algorithm calling the rules.

Either or both of rules database 418 and rule set 420 may be a searchable database. If searchable, a user may search the appropriate database(s) for a specific object, and report all the rules that are related to the specific object.

Each rule in rule set 420 may include a small header section that defines how the rule will interact with design analyzer 402. For example, the header section may define how to display the rule and how to run the rule. The header section may also define options and a required state for the rule. The non-header portions of the rule may define the algorithm for running the rule. The algorithm can be, for example, a simple one-line call to identify all the latches in a design, or it could be many lines of code to identify complex structures in the design. The level of complexity depends on the complexity of the structure the rule is checking.

Design analyzer 402 may provide built-in Tcl commands for the most common functions a rule would require. The base command “Get_logic_cone” is used herein as an example. Adding one of “-to,” “-from,” and “-through” allows a rule to access specific logic cones. The extension “-endpoints” finds the endpoints of a given path. The extension “-through filter” allows a rule to traverse through specific cells or pins, and is usually used to find logic cones that ignore buffers and/or inverters. “-Path” is an extension that returns the actual paths associated with the logic cone when the default is to return a list of cells.

The base command “Get_cells/pins/nets” is another Tcl command to which extensions can be added. The extension “-of objects” translates from a pin to a cell, while the extension “-filter” filters a list to match a specific criteria. Thus, “Get_cells-filter {@type=“latch”} will return instances of latches in a given list. In another example, a structural rule searching for large structures may instruct design analyzer 402 to traverse the netlist to find structures above a given bit size.

In yet another example of a rule, the Tcl command “Get_attribute” returns a list of attributes of design objects, such as pins, ports, cells, constraints, and designs.

Rule set 420 includes the individual rules selected to be run, as well as any options available for the individual rules. Active rules, which are rules capable of being run at a particular stage of the design, and their options may be selected by a user from a total list of rules in rules database 418. For example, a user can select whether non-compliance with a rule should result in a violation or a warning. Alternatively or additionally, design consultant 400 can select or determine the rules and options to be run. Although rules database 418 and rule set 420 are shown in FIG. 4 as two separate databases, one of skill in the relevant art(s) will recognize that they may be combined into a single rules database.

Rules that are based on information received from RTL database 410 optionally include congestion analysis rules that cause design analyzer 402 to search for one or more of: large multiplexers or multiplexer trees, large structures, modules having a large percentage of large structures, structures having high fan-in and/or fan-out ratios, and other structures that typically cause congestion problems. Congestion analysis rules can also be used to identify modules with high utility, as well as modules with high pin density. Congestion rules can be used to identify, for example, global registers that should be duplicated to reduce traffic through each register. Congestion rules can also be used to differentiate local multiplexers from global multiplexers.

If timing information has been received from timing database 408, timing analysis can also be performed on information received from RTL database 410. Timing analysis can use different delay modes including logic level, zero net-load, and zero-load models of timing. Any of timing, structural, and/or physical implementation-based analysis can be used to improve or report issues with physical partitioning.

Rules database 418 also includes synthesis-based rules that cause design analyzer 402 to analyze information from synthesis database 412. For instance, design analyzer 402 can determine whether large structures with negative slack exist. If so, design analyzer 402 may recognize that the complexity of the large structure causes the negative slack, and that the large structure may need to be broken into multiple smaller structures. Similarly, design analyzer 402 can search for high fan-in and/or fan-out registers with negative slack. Other synthesis-based rule analyses may include, without limitation, identifying unregistered input and/or output ports, identifying snake paths, determining the utilization of the objects in the design, and/or congestion analysis.

Rules database 418 also includes physical implementation-based rules. Similarly to synthesis-based rules, implementation-based rules can be used to analyze congestion and routing-based timing. Implementation-based rules can also be used to analyze, for example and without limitation, pin-pair distance, which checks whether distances between a component and a pin varies between pins; net bounding box size, which follows the links between a component and its pins to determine the total area covered by the net; critical path length; maximum capacitance; partitioning; physical-to-physical hierarchy node connections, which examine whether two nodes should be placed together due to critical timing or due to the number of connections; and the number of small partitions, which could slow a floorplanning tool that is optimized for analyzing larger partitions. Implementation-based rules can also be used to analyze congestion criteria such as, without limitation, pin spacing, number of blocks in the center of the chip, number of pins in the center of the chip, highly connected modules placed far apart, snake paths (where signals are transferred between the same blocks multiple times), poor RAM/I/O placement, and low porosity components.

Design analyzer 402 incorporates a synthesis engine 426 that can map to a technology-specific vendor library such as object library 110 in FIG. 1 or timing database 408 in FIG. 4. Technology-specific analysis is required for some issues. For example, static timing analysis capabilities are required for checking complex timing. Design analyzer 402 enables timing and area analysis features that are not available in traditional systems. Because of this mapping, design consultant 400 can identify, for example, high area components or timing critical paths that require synthesis technology to optimize logic with a vendor-specific library and with complex timing constraints.

Design analyzer 402 may include a static timing analysis engine 428 that reads industry standard timing constraints, such as Synopsys SDC. Timing analysis engine 428 may support a large set of constraints including, for example, path exceptions with -from, -to, and -through options. Timing analysis engine 428 is effective when using logic objects such as TeraGates™, since logic objects provide a reduction in the number of instances that must be analyzed. However, operation on a gate-level netlist is possible, though it is inherently slower. Further, design analyzer 402 can examine a pre-mapped netlist for checks such as missing clocks or unconstrained ports. Using logic objects, design analyzer 402 optionally detects complex issues such as missing multiple paths and false paths.

One or more rules in rules set 420 are optionally associated with one or more databases. Thus, if information is not yet contained in a particular database, the rule will return an error message and will not complete. For example, if design analyzer 402 attempts to call a physical implementation-based rule, the rule will query physical database 414. If physical information has not yet been received through, for instance, floorplanning or placement, physical database 414 will be empty. The rule query will recognize that the database is empty and will report an error without completing its run.

Different types of rule analysis may be combined to identify the root cause of issues. For example, physical implementation-based congestion analysis may be correlated with structural analysis to identify RTL structures that are the root cause of an issue. Physical implementation-based timing analysis using actual net delays and structural analysis can be combined to find structures at the root of a timing delay. Combining synthesis timing results and structural analysis can identify objects causing slack issues, such as large multiplexers and objects with high register fan-in and/or fan-out, as well as perform logic level analysis with slack. High physical area related to large objects and/or frequently-used modules can also be determined by combining different styles of rule analysis.

Case analysis may also be performed by design analyzer 402. Case analysis is required to do accurate timing analysis for today's advanced ASICs. With case analysis, if issues develop, the real objects behind those issues are identified by design analyzer 402. Case analysis helps prevent false reporting of issues. Design analyzer 402 may then report the rules responsible for a violation and give a suggestion on how to solve the violation. Design analyzer 402 then may provide insight into how much the design would improve if changes were made. Case analysis allows testability issues to be checked without test vectors or stimulation. For example, cross-clock domain can be analyzed to determine whether two communicating registers are on different clocks. Optionally, a synchronizer can be included in the case analysis so that design analyzer 402 recognizes the most common synchronization circuit, and reduces false positives.

In these ways, design implementation checking can verify that a design meets timing and area goals. It can also verify that the physical implementation is feasible. Structural issues affecting the implementation of the design can be identified, and accordance with timing constraints can be checked.

After at least one rule is run on the IC design, design analyzer 402 generates as output a status database 422 and at least one report 424. Report 424 can be either textual or graphical. FIG. 5 is a screenshot of an example report 500 created by a design consultant such as design consultant 400. Report 500 includes tabular subreports 502, 504, and 506 and graphical subreports 508 and 510. One of skill in the relevant art(s) will understand that any number and type of reports may be included in report 500.

In the example shown, tabular subreports 502, 504, and 506 are reports on individual rules. Subreport 502 is a report of warnings resulting from a rule searching for unregistered partition outputs. Subreport 504 is a report showing a hierarchical tree of registers, while subreport 506 reports the individual register resulting from a rule searching for all registers within the hierarchy.

Individual rule reports may include graphical portions. For example, graphical subreports 508 and 510 also include tabular sections. One of skill in the relevant art(s), however, will recognize that the graphical subreports may be presented without related tabular reports. Subreport 510 includes results from a rule searching for registers with negative slack, where slack is the difference between the amount of time it should take for a register to run and the amount of time it actually takes for a register to run. Negative slack means that the register takes longer to run than it should, which could affect the overall timing of the chip. Several types of graphical reports may be displayed. For example, and without limitation, report 500 may include histograms (like subreport 510), pie charts (like subreport 508), bar charts, tree tables, simple tables, or any combination of the above. A report may include a summary wherein selection of a portion of the summary will cause relevant material to be displayed.

After synthesis-based rules are run, report 424 may include utilization targets to feed forward to a physical implementation processor. After implementation-based rules are run, report 424 may include congestion reports, such as incremental congestion, repartitioning suggestions, or simulation results. Additionally or alternatively, report 424 may include an output floorplan, including, for example and without limitation, floorplan constraints, timing budgets based on the physical design, a wireload model, the source RTL, and/or a physical netlist.

Information contained in report 424 may be interpreted by a user according to, for example, predetermined documentation such as a guide. Additionally or alternatively, the information in report 424 may be interpreted via automated analysis. Report 424 may offer suggestions for high level optimization and/or restructure of the RTL and/or gate level netlist based on one or more of timing, power, area, and congestion analysis in the physical domain. For example, to reduce congestion, some local multiplexers may be restructured to global multiplexers. In another example, global registers may be duplicated. In yet another example, to reduce congestion, clusters of objects may be created.

Report 424 may be saved by a user for future use. In an example future use, a user may verify that one or more results in report 424 is an acceptable violation. Therefore, the violation need not be displayed in subsequent reports. Such previously verified results may be flagged, for example, manually or automatically. Subsequently, the design may be analyzed again, based on a revised version of the source code, a revised version of the software, a revised representation of the design due to changes in the design analysis tool, and/or a revised version of the ruleset. Previously verified results, such as the flagged results, may be removed from subsequent design report so that only non-verified violations are reported.

In another example, a saved report may be compared with a current report so that only differences between the saved and current report are displayed. In this manner, each subsequent report displays only new rule violations instead of all rule violations.

FIG. 6 is a flowchart of an example rule-based design analysis method 600. Method 600 may be performed, for example, by design consultant 400. In step 602, source code is received. The source code may be, for example, RTL source code, and may be received from, for example, an outside vendor.

In step 604, the source code received in step 602 is converted to a plurality of objects. These objects may be gate-level objects or logic objects, such as standard cells and/or gate abstractions, such as described above with reference to FIGS. 1 and 2. Step 604 occurs in, for example, a parser, and produces an RTL database such as, for example, RTL database 306.

Method 600 then proceeds to decision step 606. If no physical layout exists, then method 600 proceeds to either step 608 or step 610, which are used to produce a physical layout. If a physical layout already exists, method 600 proceeds to step 616 in which the physical layout is analyzed.

In step 608, the plurality of objects produced in step 604 may be analyzed to identify semantic issues. Since synthesis has not yet occurred, more advanced analysis is not yet possible. Step 608 may be performed, for example, by design analyzer 402 in design consultant 400.

After step 608, method 600 proceeds to step 610. Alternatively, step 610 can be reached by skipping step 608. In step 610, the plurality of objects is synthesized. Step 610 may correspond to step 308 in method 300, discussed above. Step 610 produces a synthesis database, such as synthesis database 310.

In step 612, the synthesized objects are analyzed to identify synthesis, timing, or area issues. Step 612 incorporates technology-specific timing and area optimization. This removes false positive reports, and allows hierarchy manipulations (e.g., grouping and/or ungrouping) to accurately represent design flow. These hierarchy manipulations may be performed automatically in step 612, manually by a user, or a combination of the two.

Physical layout of the objects occurs in step 614 through floorplanning, placement, and routing. This provides a physical prototype of the design that can be checked for a wide range of physical design issues such as, for example and without limitation, early congestion analysis, area analysis, long wire detection, and timing based on the physical prototype. Access to actual physical implementation details, and ability to verify a design with these details, offers significant advantage over rule checkers that do not include an analysis of the physical implementation. Physical implementation checking considers timing based on a detailed physical model, and can identify floorplan issues such as, without limitation, long wires and pin congestion. Early analysis of the physical implementation finds issues and develops a viable floorplan before RTL handoff to the back end, reducing the number of back-end iterations required. Step 614 combines steps 316 and 322 of method 300, and produces a physical database, such as physical database 318.

In step 616, the objects and their connections are analyzed to identify semantic, structural, and/or implementation issues. This analysis may occur by, for example and without limitation, searching through the design layout for specific types of connections or searching through the netlist for specific types of objects. In one embodiment, information concerning the objects and their connections results from step 612 of method 600. In another embodiment, the physical layout is generated separately, and the information is passed into method 600 for analysis. For example, a physical design exchange format (“PDEF”) file generated by another floorplanning or placement tool may be read into, for example, design consultant 400. This provides the availability of iterations between tools, or even use of another floorplanner to generate the floorplan to be analyzed by method 600. Although method 600 will be described with reference to PDEF files, one of skill in the relevant art(s) will recognize that any physical description language, including but not limited to Cadence DEF and SOCE “fp” files, may be used without departing from the spirit and scope of the present invention.

In step 620, a status report is generated detailing the analysis of step 616. The status report generated may be, for example, textual and/or graphical as described with respect to FIG. 5. Reports generated by method 600 identify all types of issues at the RTL level, where it is more effective to fix than after back-end implementation. If changes are made to fix any issues found, method 600 can be repeated. The use of abstracted logic objects such as TeraGates™ shorten the runtime of method 600 to allow flexibility and time for repeating method 600 if needed. Any changes may be made manually by a user or automatically by, for example, a repair manager within design analyzer 402.

After method 600 runs successfully, in that it finds few non-compliant objects, a front-end floorplan may be developed. The floorplan can then be fed forward to a back-end processor. Synthesis, physical constraints, and partitioning based on RTL analysis may also be fed forward, as can an optimized physical netlist. If a back-end processor further updates the floorplan, method 600 may be re-run on the updated floorplan to verify compliance with the ruleset.

Several types of constraints are useful if the information is fed forward to a back-end tool. In an example, utilization targets for each module based on structural and/or physical analysis prevent congestion due to over-utilization. In another example, the placement of different modules can also be seeded, or given an order of priority. For instance, an ordered list of nets to place and route can be identified based on high fan-out nets or by timing analysis in synthesis or physical domains. In yet another example, net weights on objects such as critical path objects or high fan-in or fan-out registers can be determined, as can groupings based on local or global multiplexing, identified control registers, and/or data path analysis.

Options, scripts, and/or flags for gate-level synthesis or gate-level place and route tools may also be provided, such as identifying the proper run script based on the structural analysis of the design. For example, if the design is data path centric, use of MC-Inside, a module compiler designed by Synopsys, may be appropriate. If the sub-design is mostly control logic and on the critical path, flattening in a design compiler may be useful. Or, if the sub-design is estimated to be high power and/or have a high area, proper flags can be used to reduce both. In this manner, the design consultant can identify the best program to complete portions of the IC design process.

B. Graphical User Interface

A design consultant such as design consultant 400 may be operated via a graphical user interface (“GUI”). FIG. 7 is a screenshot of an example GUI 700. GUI 700 includes a rule set interface 702, source RTL window 704, timing window 706, summary report window 708, and individual rule report window 710. GUI 700 may be implemented through a graphical design language, such as Java or Tcl/TK. Design consultant 400 may provide the reports in GUI 700, but may additionally allow for connections to external Tcl and Tk applications for customized views and reporting.

Rule set interface 702 lists various rules available for the phase in the IC design process at which the consultant is being run. For example, if synthesis has not been run, rule set interface 702 can optionally hide rules that require synthesis before they are run. Rule set interface 702 includes several tabs. Each tab includes rules pertaining to a particular category. In the example of FIG. 7, the rule categories are General, Constraints, Design, Physical Implementation, Chip Integration, and Methodology. After the rule analysis is complete, rule set interface 702 displays the status of each rule.

For example, in interface 702, rules Gated Clock Check, Gated Async Set/Clear, and Clocks Used As Data ran and passed. Rules Cross Clock Domain Paths, Unregistered Outputs, and Feed Through Paths ran and failed. Rules Back To Back Registers and Combinational Feedback Loops were not run. As shown, options can be selected for each rule, and each rule can be viewed through rule set interface 702.

Source RTL window 704 displays the source RTL for the design being analyzed. If cross-probing is enabled, which will be described further below, source RTL window will display the lines of RTL relevant to a particular object or register in the IC design.

Timing window 706 includes critical path list 712, critical path object list 714, and critical path schematic 716. Critical path list 712 may display, for example, results of a rule searching for paths that do not meet given timing constraints. Paths that do not meet timing are referred to as critical paths. Critical path object list 714 displays information about each element in the critical path, such as delay through the object and net capacitance. Critical path schematic 716 includes a schematic showing the connections between each element in the critical path, along with the timing for each element in the critical path. Timing window 706 may display multiple critical path schematics when multiple paths do not meet timing constraints.

Summary report window 708 lists the available rules along with their status. In the present example, summary report window 708 also lists the number of warnings and errors associated with each of the rules.

Individual rule report window 710 reports on a specific rule, such as, in the window shown, a Cross Clock Domain rule. Individual rule report window 710 may include, for example, timing information on registers that are flagged by the rule.

Additional schematic views (not shown) may be available for all logical, synthesis, physical, and timing modes of the tool. The schematics may provide a number of features that allow for increased analysis. For example, coloring may be user settable or may be controllable through the Tcl code for the rules and the java code for the GUI 700. Different types of objects, such as logic objects, may have a default coloring to allow a quick overview of design structures. Alternatively or additionally, GUI 700 may include a gray mode, which selected cells red, for example, and all other cells gray. This makes it easier to identify selected objects in large schematics. GUI 700 may also include bus-level schematics, which simplify schematics by minimizing the number of routes shown. Related objects may automatically be grouped in various schematics. GUI 700 may have the capability of selecting fan-in and/or fan-out cones. The underlying Tcl language may allow a user to set and/or manipulate a selection set through the Tcl code.

A person of skill in the relevant art(s) will recognize that alternative numbers and types of windows may be displayed by a GUI such as GUI 700 without departing from the spirit and scope of the present invention.

The use of logic objects, such as TeraGates™, make it easier to analyze the structure of a design in schematic and/or timing views, such as critical path schematic 716. Logic object-level schematics are more readable since they include fewer objects than a corresponding gate-level schematic. For example, an ADDER, which includes hundreds of individual gates, can be displayed as a single logic object. Bit-stacking, wherein a multi-bit register is treated as a single component, may provide further simplification.

C. Cross-Probing within the Design Consultant

Additionally, through the use of cross-probing, objects in the IC design can be mapped back to the source RTL for easy inspection and/or alteration of relevant source RTL. Cross-probing pinpoints problems that would be difficult or impossible to correlate with a source RTL issue without the link back to the source RTL. For example, an IC design tool may generate instances of objects representative of one or more features within the source code. Graphical representations of the source RTL include a reference, sometimes referred to as the location attribute, to the section of source RTL that defines the object. Since each graphical representation contains a reference to the source code, each representation of a particular object can be linked to other representations of the same object. This is referred to herein as cross-probing between graphical representations of the source code. Methods and systems for cross-probing can be found in application Ser. No. ______, filed ______ (Attorney Docket No. 2210.0070001), entitled “Methods and Systems for Cross-Probing in an Integrated Circuit Design,” which is incorporated herein by reference in its entirety. The location attribute may be maintained through all design phases, including analysis, elaboration, synthesis, physical prototyping, and optimization.

In the design consultant 400, when a particular component is not compliant with a rule, cross-probing can be used to quickly locate the relevant lines of source RTL. Cross-probing can also be used to display other representations of the same object, making reasons for non-compliance easily found. Once the problem is discovered, changes can be made, if necessary, directly to the source RTL. Correlating design issues directly with the source RTL allows physical implementation problems to be checked at the RTL level where they are more easily fixed, rather than by attempting to fix them through placement at the back end. For example, the congestion issues discussed with respect to FIGS. 8-16 could be solved when a design consultant identifies the issues and automatically links to the source RTL to correct those issues.

Cross-probing can also be used as a visualization tool in generating reports. When a non-compliant cell or cells is found, the design analyzer, such as design analyzer 402, has access to the source RTL and can, for example, generate schematics, highlight or color cells of interest, and provide links back to the original RTL.

For example, individual rule report window 710 of GUI 700 may report on a rule analyzing congestion. The congestion rule may flag a particular object. That object may be highlighted automatically or by a user. Because of cross-probing, a representation of that object in timing window 706 will also be highlighted. The source code related to that object will be displayed source RTL window 704. Each window can be analyzed, either manually or automatically, to determine reasons for the lack of compliance. Once the reason is determined, the problem may be fixed by, for example, changing the source RTL. The design consultant may allow a user to fix a problem manually or the design consultant may automatically fix any problems discovered through, for example, a repair manager within, for example, design analyzer 402.

Additionally, cross-probing can generate a layout overlay report. A layout overlay report provides a “snapshot” of a layout view and allows a particular rule to color that layout by any criteria. For example, a congestion rule could highlight objects based on pins-per-area. The layout overlay could also be used to highlight by clock domain, timing slack, or any number of other criteria.

Cross-probing may also be used between two or more rule report windows. The rule report windows may be the result of running a single ruleset. If an object is identified in one rule report as a problem for the design, cross-probing between rule report windows allows for an indication of other rules for which the object is a problem. For example, a multiplexer may be reported for both a “high congestion” rule and a “timing critical path” rule. If a user selects the multiplexer in the high congestion rule report, other reports in which the multiplexer appears, such as the timing critical path report, may also be displayed. Cross-probing results in a selection of the multiplexer in the timing critical path rule report, as well as any other rule reports the multiplexer appears in.

Using cross-probing, a design consultant according to the present invention can integrate RTL analysis with technology-specific timing and physical implementation. Thus the design consultant can include a flexible platform for checking designs with a focus on identifying timing, area, and physical design issues at the RTL level. Maintaining the cross-probing references through the back end simplifies any changes that may be caused due to implementation at the back end. If iterations are required, the cross-probing references can be used by designers at either the back end or front end to update the appropriate source RTL. The cross-probing may also be used with a feedforward flow to provide links to external synthesis and place and route tools. An example is the Tera Systems' generated two way link between Cadence SOCE and the TeraForm product.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A method of automated rule analysis in an integrated circuit design, comprising:
(a) receiving source code representative of the integrated circuit design;
(b) converting the source code to a plurality of objects representative of the source code; and
(c) analyzing the objects to identify design issues based on a physical layout of the objects, wherein the physical layout includes information about interconnections between objects in the plurality of objects, a physical size of objects in the plurality of objects, a physical shape of objects in the plurality of objects, or placement of objects in the plurality of objects.

2. The method of claim 1, wherein said step (c) comprises:
(i) inputting a set of rules;
(ii) analyzing the objects for compliance with the set of rules; and
(iii) outputting a result report.

3. The method of claim 2, wherein the set of rules includes physical hierarchy and partitioning rules.

4. The method of claim 2, wherein the set of rules includes congestion rules.

5. The method of claim 2, wherein the set of rules is based on a set of constraints, wherein said set of constraints includes at least one of structural constraints, timing constraints, physical constraints, and feedforward constraints.

6. The method of claim 5, wherein the set of rules is based on one or more of a combination of physical and structural constraints or a combination of timing and structural constraints.

7. The method of claim 2, wherein said step (c) further comprises:
(iv) interpreting the result report.

8. The method of claim 7, wherein the result report is interpreted according to predetermined documentation.

9. The method of claim 7, wherein the result report is interpreted automatically to produce at least one solution to a design issue.

10. The method of claim 2, wherien the set of rules is included in a searchable rules database.

11. The method of claim 2, wherein said step (c) further comprises:
(iv) selecting an object in the rule result report;
(v) displaying a list of other rule result reports in which the selected object appears; and
(vi) cross-probing between the rule result report of said step (c)(iii) and the other rule result reports in which the selected object appears.

12. The method of claim 2, wherein said step (c) further comprises:
(iv) verifying at least one result in the result report;
(v) repeating said steps (a), (b), (c)(i), (c)(ii), and (c)(iii) for an updated representation of the design based on at least one of the group consisting of a revised source description, revised software, revised options to the software, and a revised ruleset; and
(vi) removing from the repeated result report the at least one verified result.

13. The method of claim 2, wherein said step (c) further comprises:
(iv) saving the result report as a saved result report;
(v) repeating said steps (a), (b), (c)(i), and (c)(ii) for an updated representation of the design based on at least one of the group consisting of a revised source description, revised software, revised options to the software, and a revised ruleset;
(vi) outputting a current result report for the updated representation of the design; and
(vi) reporting the differences between the saved result report and the current result report.

14. The method of claim 1, wherein said step (c) further comprises analyzing the objects to identify design issues based on physical structures of individual objects.

15. The method of claim 1, wherein the objects include references to associated lines of the source code, and wherein said step (c) comprises cross-probing between the objects and the source code when design issues are identified.

16. The method of claim 1, wherein the design issues relate to a timing status of at least one of the objects.

17. The method of claim 1, further comprising:
synthesizing the objects; and
analyzing the objects to identify synthesis-based design issues.

18. The method of claim 1, further comprising:
supplying object analysis from the analysis step to downstream synthesis and physical implementation tools; and
generating proper settings for the tools based on the object analysis, such that at least one of area, timing, power, and congestion results of the tools is improved.

19. The method of claim 1, wherein at least one object in the plurality of objects is an aggregate of smaller objects

20. A method of automated rule analysis of an integrated circuit design, comprising:
(a) receiving source code including gate-level netlists;
(b) converting the source code to a plurality of cells representative of the source code, wherein at least one cell in the plurality of cells includes a reference to associated lines of the source code; and
(c) analyzing the plurality of cells for compliance with a set of rules.

21. The method of claim 20, further comprising before said step (c):
synthesizing the plurality of cells.

22. The method of claim 21, further comprising before said step (c):
floorplanning the plurality of cells.

23. The method of claim 22, further comprising before said step (c):
placing and routing the plurality of cells.

24. The method of claim 20, wherein the set of rules includes at least one of a semantic rule, a structural rule, an implementation rule, a congestion rule, and a timing rule.

25. The method of claim 20, wherein the plurality of cells is analyzed based on a physical layout of the plurality of cells.

26. The method of claim 20, further comprising:
(d) generating a report regarding the compliance status of the integrated circuit design.

27. The method of claim 26, wherein the report is generated based on a case analysis of the integrated circuit design.

28. A rule-based design consultant for an integrated circuit design, comprising:
(a) a rule library;
(b) a database interface to link the rule-based design consultant with at least one database, wherein the at least one database includes information about cells in the integrated circuit design, and wherein the at least one database includes a physical database;
(c) a rule analyzer for analyzing the information in the at least one database according to at least one rule in the rule library; and
(d) a report generator.

29. The rule-based design consultant of claim 28, wherein the at least one database further includes a timing database.

30. The rule-based design consultant of claim 29, wherein the at least one database further includes a source code database and a synthesis database.

31. The rule-based design consultant of claim 28, further comprising a status database, wherein the status database includes information about cells in the integrated circuit design that do not comply with at least one rule in the rule library, and wherein the report generator generates reports based on the information in the status database.

32. The rule-based design consultant of claim 28, wherein the report generator generates both graphical and textual reports.

33. The rule-based design consultant of claim 32, wherein the graphical reports include at least one of piecharts; bar graphs; histograms; hierarchical reports; placement, routing, and congestion views; and synthesis, physical, or timing schematics.

34. The rule-based design consultant of claim 28, further comprising a repair manager, wherein the repair manager automatically responds to non-compliant cells indicated by the rule analyzer.

35. The rule-based design consultant of claim 34, wherein the repair manager responds to non-compliant cells by altering source code for the integrated circuit design.

36. The rule-based design consultant of claim 28, wherein the rule library includes a list of rules and options for each rule in the list of rules.

37. The rule-based design consultant of claim 36, wherein the options for each rule are user-customizable.

38. The rule-based design consultant of claim 36, wherein the list of rules includes at least one of a combination physical and structural rule and a combination timing and structural rule.
